(19) United States
(12) Patent Application Publication
(10) Pub. No.: US 2009/0241502 A1
(43) Pub. Date: Oct. 1, 2009

(54) MOWER DECK WITH REMOVABLE DECK RING EXTENSION

(76) Inventor: Todd Hofmann, Saskatoon (CA)

Correspondence Address: STITES & HARBISON PLLC, 1199 NORTH FAIRFAX STREET, SUITE 900, ALEXANDRIA, VA, 22314, US

(21) Appl. No.: 12/179,056

(22) Filed: Jul. 24, 2008

(30) Foreign Application Priority Data
Mar. 27, 2008 (CA) 2,627,414

(51) Int. Cl. A01D 67/00; A01D 34/52

(52) U.S. Cl. 56/320.1; 56/255

(57) ABSTRACT

mower deck apparatus comprising a mower deck adapted for mounting thereto of a blade assembly such that blades of the blade assembly can rotate under the mower deck about a substantially vertical blade axis and move along a blade path. A base deck ring extends downward from a lower surface of the mower deck at a location above the blade path of a mounted blade assembly, and a deck ring extension is removably attachable to the base deck ring such a lower edge of the deck ring extension is located below a lower edge of the base deck ring.

This invention is in the field of rotary mowers and in particular a mower deck that supports a mower blade assembly thereunder.

### BACKGROUND

A common pan type of rotary mower blade assembly comprises a horizontally oriented pan mounted under the mower deck and driven such that the pan rotates at high speed about a vertical pan axis. Mower blades are pivotally attached about the edges of the pan such that the blades extend out from the pan under centrifugal force and cut vegetation passing under the mower deck. This type of blade assembly is beneficial where stumps and rocks are encountered, because the blades will pivot back when they strike an obstruction, and as well the pan is convex so the pan will ride over obstructions like stumps or the like.

Where finer chopping is desired, another type of double blade assembly provides a horizontal blade bar or the like that is connected at a midpoint to a vertical shaft and rotates about the vertical shaft axis. Upper and lower blades are mounted at each end of the blade bar such that the two blades extend out from the ends of the blade. One or more stationary blades are mounted under the deck in a fixed position oriented such that as the blade assembly rotates, the stationary blades pass between the upper and lower blades.

A mower deck typically comprises a horizontally oriented steel plate with a blade drive mechanism, support wheels, hitch, blade, and the like attached thereto to thereby provide a complete rotary mower apparatus. In use, when the blades rotating at high speed strike an obstruction, the blade may be bent and experience severe damage, and further a bent blade can contact the deck that is above the blade, and tear holes in same or otherwise cause significant damage. In order to protect the mower deck from such damage from bent blades it is known to provide a deck ring. The deck ring extends downward from the bottom surface of the mower deck and is typically circular with a center at the rotational axis of the blade assembly. The deck ring has a diameter less than that of the blades in the extended rotating position, such that the deck ring is above the spinning blades. Thus if a blade is bent upward, it will contact the deck ring and not the mower deck, thereby reducing the risk of damage to the deck.

### SUMMARY OF THE INVENTION

It is an object of the present invention to provide a mower deck apparatus that overcomes problems in the prior art.

When configuring a deck ring it is desirable to locate the bottom edge of the deck ring quite close to the spinning blades to limit as much as possible the upward movement of the blades out of their desired path of travel. Thus where a pan type blade assembly is used, the deck ring is deeper and extends downward farther from the lower surface of the deck than where a double blade assembly is used. The upper blade of the double blade assembly moves along a path that is vertically located higher and closer to the deck than the path of the blade in a pan blade assembly. Thus a mower manufacturer typically will make a deck with a shallow ring welded to the lower surface thereof for use with the double blade assembly, and will make a deck with a deeper deck ring welded to the lower surface thereof for use with a pan type blade assembly. The mower decks for each then are not interchangeable, with the result that an increased inventory of mower decks is required to be maintained.

Deck rings, and in particular the deeper deck rings of the pan blade assemblies, are subject to damage by bent blades, rocks, and the like.

With the present invention the deck ring extension can be removed if desired to accommodate various blade assemblies, and also can be removed for repair or replacement after damage.

In a first embodiment the present invention provides mower deck apparatus comprising a mower deck adapted for mounting thereto of a blade assembly such that blades of the blade assembly can rotate under the mower deck about a substantially vertical blade axis and move along a blade path. A base deck ring extends downward from a lower surface of the mower deck at a location above the blade path of a mounted blade assembly, and a deck ring extension is removably attachable to the base deck ring such a lower edge of the deck ring extension is located below a lower edge of the base deck ring.

In a second embodiment the present invention provides a rotary mower apparatus comprising a mower deck adapted for movement along the ground. A blade assembly is mounted to the mower deck such that blades of the blade assembly rotate under the mower deck about a substantially vertical blade axis and move along a blade path. A base deck ring extends downward from a lower surface of the mower deck at a location above the blade path, and a deck ring extension is removably attachable to the base deck ring such a lower edge of the deck ring extension is located below a lower edge of the base deck ring.

In a third embodiment the present invention provides a method of providing a mower deck suitable for mounting thereto of a pan blade assembly and suitable for mounting thereto of a double blade assembly comprising upper blades and lower blades, such that blades of the blade assemblies can rotate under the mower deck about a substantially vertical blade axis and move along a blade path. The method comprises fixing a base deck ring to a lower surface of the mower deck such that the base deck ring extends downward from a lower surface of the mower deck at a location above the blade path of a mounted double blade assembly, and providing a deck ring extension removably attachable to the base deck ring such a lower edge of the deck ring extension is located below a lower edge of the base deck ring and above a path of the upper blades.

### DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a side view of an embodiment of a mower deck apparatus of the present invention mounted on wheels for movement along the grounds;

FIG. 2 is a bottom perspective view of the embodiment of FIG. 1 with a double blade assembly mounted thereon;

FIG. 3 is a schematic side view of the blades and mower deck apparatus with the double blade assembly mounted thereon as in FIG. 2;

FIG. 4 is a bottom perspective view of the embodiment of FIG. 1 with a pan blade assembly mounted thereon;

FIG. 5 is a schematic side view of the blades and mower deck apparatus with the pan blade assembly mounted thereon as in FIG. 4.

### DETAILED DESCRIPTION OF THE ILLUSTRATED EMBODIMENTS

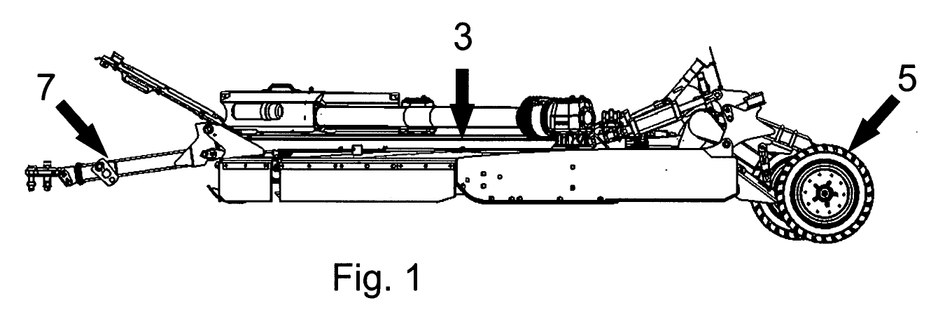

FIGS. 1-5 illustrate an embodiment of a mower deck apparatus 1 of the present invention. The apparatus 1 comprises a mower deck 3 adapted for movement along the ground. The illustrated mower deck 3 is mounted on wheels 5 and includes a hitch 7 at the front end thereof for attachment to a towing vehicle. Alternatively the mower deck 3 could be mounted directly on a vehicle, such as by a common three point hitch or other known arrangement.

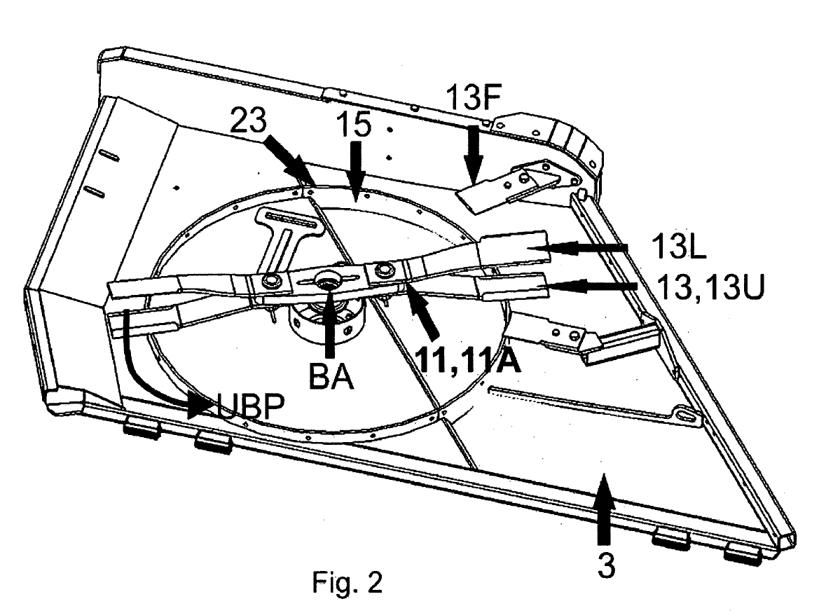

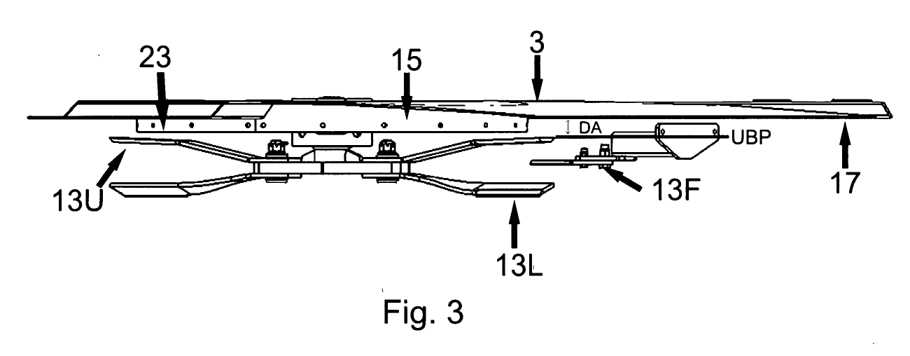

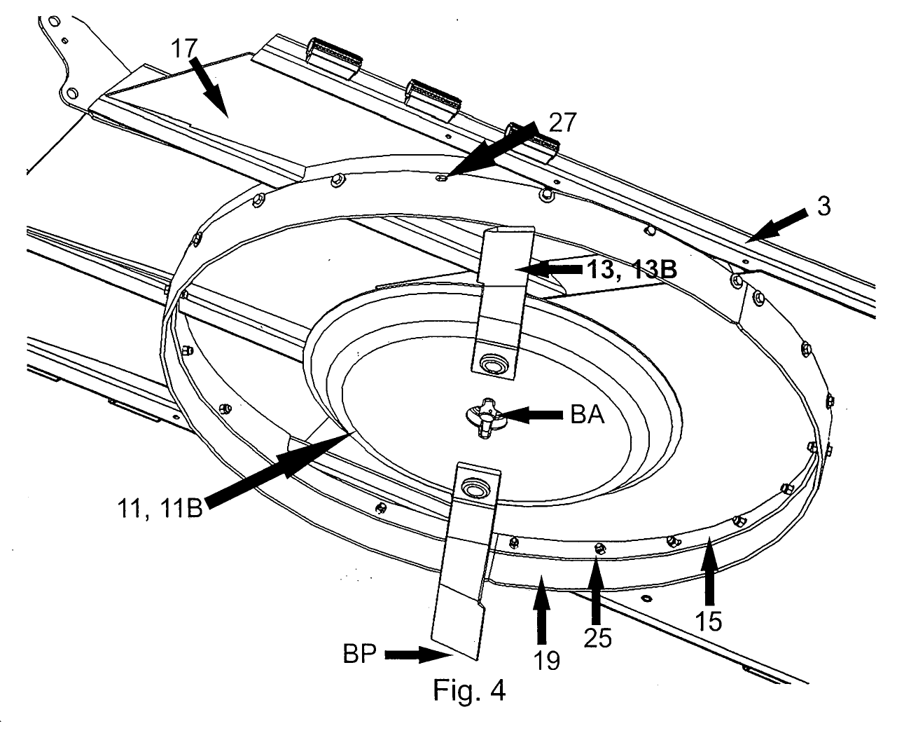

As seen in FIGS. 2 and 4, the mower deck 3 is adapted for mounting thereto of a blade assembly 11 such that blades 13 of the blade assembly rotate under the mower deck 3 about a substantially vertical blade axis BA and move along a blade path BP. The blade assembly shown in FIGS. 2 and 3 is a double blade assembly 11A with upper blades 13U and lower blades 13L. A fixed blade 13F is typically attached to the mower deck 3 and is oriented such that the fixed blade is between the upper and lower blades 13U, 13L as the blade assembly 11 rotates, providing added chopping action.

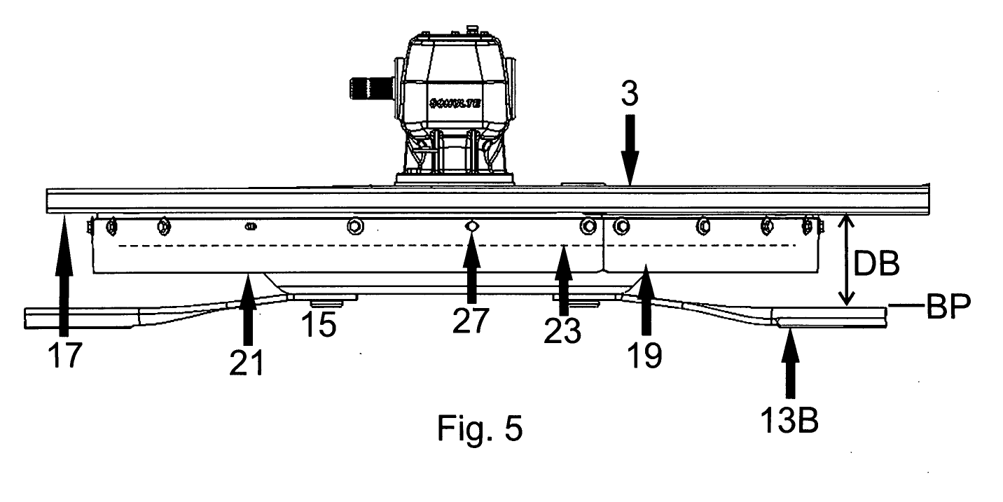

The blade assembly shown in FIGS. 4 and 5 is a pan blade assembly 11B with blades 13B pivotally attached to a spinning pan 14.

In the double blade assembly 11A the upper blade path UBP of the upper blade 13U is a distance DA from the lower surface 17 of the mower deck 3 as seen in FIG. 3. In the pan blade assembly 11B, the blade path BP of the blades 13B is a distance DB from the lower surface 17 of the mower deck 3 as seen in FIG. 5, and the distance DB is greater than the distance DA.

A base deck ring 15 extends downward from a lower surface 17 of the mower deck 3 at a location above the blade path BP as illustrated. A deck ring extension 19 is illustrated in FIG. 4 and is removably attachable to the base deck ring 15 such that a lower edge 21 of the deck ring extension 19 is located below a lower edge 23 of the base deck ring 15.

With the deck ring extension 19 attached as illustrated in FIGS. 4 and 5, the mower deck 3 is adapted for mounting the pan blade assembly 11 B, with the lower edge 21 of the deck ring extension 19 above the blade path BP of blades 13A of the mounted pan blade assembly 11A.

With the deck ring extension 19 removed as illustrated in FIGS. 2 and 3, the mower deck 3 is adapted for mounting thereto of the double blade assembly 11A comprising upper blades 13U and lower blades 13L, with the lower edge 23 of the base deck ring 15 above the path UBP of the upper blades.

Thus with either the double blade assembly 11A or the pan blade assembly 11B, the lower edge of the protective deck ring is in proximity to the path of the blades that are nearest to the lower surface of the mower deck 3. Thus the mower deck apparatus 1 of the invention, comprising the mower deck 3 with the attached base deck ring 15 and removable deck ring extension 19, provides a versatile mower deck that can be used with either type of blade assembly 11.

In addition, if the deck ring extension 19 is damaged, same can simply be removed and replaced or repaired. The pan type blade assembly is more commonly used where there are obstructions such as stumps, rocks, and the like, and so the deck ring is more subject to damage and the ease of replacement provided by the present invention is beneficial.

In the illustrated apparatus 1 the base deck ring 15 is substantially circular with a center at the rotational axis BA of the blade assembly, and has a diameter less than that of outer ends of blades 13 when in an extended rotating position, such as when operating to cut vegetation. The base ring extension 19 is removably attached to the base deck ring 15 by bolts 25 through corresponding holes 27 defined by the base deck ring 15 and the deck ring extension 19. The inside diameter of the deck ring extension 19 is slightly greater than the outside diameter of the base deck ring 15, such that the deck ring extension 19 can slide over the base deck ring 15 for attachment.

If other blade assembly configurations are to be used, deck ring extensions can be provided in a variety of configurations to accommodate each assembly.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

What is claimed is:

1. A mower deck apparatus comprising:
a mower deck adapted for mounting thereto of a blade assembly such that blades of the blade assembly can rotate under the mower deck about a substantially vertical blade axis and move along a blade path;
a base deck ring extending downward from a lower surface of the mower deck at a location above the blade path of a mounted blade assembly;
a deck ring extension removably attachable to the base deck ring such that a lower edge of the deck ring extension is located below a lower edge of the base deck ring.

2. The apparatus of claim 1 wherein, with the deck ring extension attached, the mower deck is adapted for mounting thereto of a pan blade assembly and wherein the lower edge of the deck ring extension is above the blade path of blades of a mounted pan blade assembly.

3. The apparatus of claim 1 wherein, with the deck ring extension removed, the mower deck is adapted for mounting thereto of a double blade assembly comprising upper blades and lower blades, and wherein the lower edge of the base deck ring is above a path of the upper blades.

4. The apparatus of claim 1 wherein the base deck ring is substantially circular with a center at a rotational axis of a mounted blade assembly, and wherein the deck ring has a diameter less than that of outer ends of blades of a mounted blade assembly in an extended rotating position.

5. The apparatus of claim 1 wherein the base ring extension is removably attached to the base deck ring by bolts through corresponding holes defined by the base deck ring and the deck ring extension.

6. The apparatus of claim 1 wherein an inside diameter of the deck ring extension is greater than an outside diameter of the base deck ring, such that the deck ring extension can slide over the base deck ring for attachment.

7. A rotary mower apparatus comprising:
a mower deck adapted for movement along the ground;
a blade assembly mounted to the mower deck such that blades of the blade assembly rotate under the mower deck about a substantially vertical blade axis and move along a blade path;
a base deck ring extending downward from a lower surface of the mower deck at a location above the blade path;
a deck ring extension removably attachable to the base deck ring such that a lower edge of the deck ring extension is located below a lower edge of the base deck ring.

8. The apparatus of claim 7 wherein the deck ring extension is attached and the blade assembly is a pan blade assembly, and wherein the lower edge of the deck ring extension is above the blade path.

9. The apparatus of claim 7 wherein the deck ring extension is removed and the blade assembly is a double blade assembly comprising upper blades and lower blades, and wherein the lower edge of the base deck ring is above a path of the upper blades and the deck ring extension is removed.

10. The apparatus of claim 7 wherein the base deck ring is substantially circular with a center at a rotational axis of a mounted blade assembly, and wherein the deck ring has a diameter less than that of outer ends of blades of a mounted blade assembly in an extended rotating position

11. (canceled)

12. The apparatus of claim 7 wherein the base ring extension is removably attached to the base deck ring by bolts through corresponding holes defined by the base deck ring and the deck ring extension.

13. The apparatus of claim 7 wherein an inside diameter of the deck ring extension is greater than an outside diameter of the base deck ring, such that the deck ring extension can slide over the base deck ring for attachment.

14. A method of providing a mower deck suitable for mounting thereto of a pan blade assembly and suitable for mounting thereto of a double blade assembly comprising upper blades and lower blades, such that blades of the blade assemblies can rotate under the mower deck about a substantially vertical blade axis and move along a blade path, the method comprising:
fixing a base deck ring to a lower surface of the mower deck such that the base deck ring extends downward from a lower surface of the mower deck at a location above the blade path of a mounted double blade assembly;
providing a deck ring extension removably attachable to the base deck ring such a lower edge of the deck ring extension is located below a lower edge of the base deck ring and above a path of the upper blades.

15. The method of claim 13 further comprising, with the deck ring extension attached, mounting a pan blade assembly to the mower deck.

16. The method of claim 14 further comprising, when the deck ring extension is damaged, removing the deck ring extension and attaching a replacement deck ring extension to the base deck ring.

17. The method of claim 13 wherein, with the deck ring extension removed, mounting a double blade assembly to the mower deck.

18. The method of claim 13 wherein the base deck ring is substantially circular with a center at a rotational axis of a mounted blade assembly, and wherein the deck ring has a diameter less than that of outer ends of blades of a mounted blade assembly in an extended rotating position.

19. The method of claim 13 wherein the base ring extension is removably attached to the base deck ring by bolts through corresponding holes defined by the base deck ring and the deck ring extension.

20. The method of claim 13 wherein an inside diameter of the deck ring extension is greater than an outside diameter of the base deck ring, such that the deck ring extension can slide over the base deck ring for attachment.
